(19) United States
(12) Patent Application Publication
(10) Pub. No.: US 2005/0162989 A1
(43) Pub. Date: Jul. 28, 2005

(54) Method and apparatus for recording and/or reproducing data and write-once information storage medium

(75) Inventors: Sung-hee Hwang, Seoul (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/019,683

(22) Filed: Dec. 23, 2004

(30) Foreign Application Priority Data
Jan. 5, 2004 (KR) 2004-374
May 14, 2004 (KR) 2004-34293

(51) Int. Cl. G11B 7/085; G11B 7/24; G11B 5/09

(52) U.S. Cl. 369/30.03; 369/275.3; 369/47.22

(57) ABSTRACT

A method and apparatus for recording and/or reproducing data, and a write-once information storage medium. The write-once information storage medium includes at least one data area for recording user data and at least one recording management data (RMD) area for recording recording management data needed to use the at least one data area by dividing the at least one data area into a plurality of borders when recording the user data in a sequential recording mode and/or a random recording mode in the at least one data area. If RMD is recorded on the write-once information storage medium and the data area is divided into a plurality of borders and/or recording zones, data can be recorded on the write-once information storage medium in a sequential recording mode or a random recording mode. Therefore, the write-once information storage medium can be used with enhanced ease and efficiency.

### CROSS-REFERENCE TO RELATED APPLICATIONS

This application claims the priority of Korean Patent Application Nos. 2004-374 and 2004-34293, filed on Jan. 5, 2004 and May 14, 2004, respectively, in the Korean Intellectual Property Office, the disclosures of which are incorporated herein by reference.

### BACKGROUND OF THE INVENTION

1. Field of the Invention

The present invention relates to a write-once information storage medium including a data area that can be divided into a plurality of borders, and more particularly, to a method and apparatus for recording data in a sequential recording mode or a random recording mode when a data area is divided into a plurality of borders and/or for reproducing the data, and a write-once information storage medium.

2. Description of the Related Art

Data recorded on a re-recordable information storage medium can be overwritten with new data. On the other hand, data can be recorded in a recording area of a write-once information storage medium only once. Thus, the data recorded on the write-once information storage medium cannot be overwritten with new data, nor can it be deleted or modified.

According to the conventional art, a data area of an information storage medium may be divided into a plurality of borders and user data may be recorded in units of borders to enhance ease of using the information storage medium, such as compatibility in data reproduction. According to the conventional art, when recording user data in a sequential recording mode, a fixed size data area may be divided into a plurality of fixed size recording zones, and the user data may be recorded in units of recording zones to efficiently use the data area of an information storage medium.

According to the conventional art, data can be recorded on a write-once information storage medium in a sequential recording mode or a random recording mode. The sequential recording mode refers to a mode for sequentially recording user data in a data area of the write-once information storage medium and the random recording mode refers to a mode for recording user data at a random location in an empty space of the data area of the write-once information storage medium.

According to the conventional art, when the write-once information storage medium is initialized, a recording mode is selected. Once a recording mode is selected, data is recorded on the write-once information storage medium only in the selected recording mode.

### SUMMARY OF THE INVENTION

In accordance with an aspect of the present invention, a write-once information storage medium storing recording management data needed to record data in a sequential recording mode or a random recording mode if a data area of the write-once information storage medium is divided into a plurality of borders is provided.

In accordance with an aspect of the present invention, a method and apparatus for recording data in the sequential recording mode or the random recording mode if the data area of the write-once information storage medium is divided into a plurality of borders are provided.

In accordance with an aspect of the present invention, a method and apparatus for reproducing data recorded on the write-once information storage medium in the sequential recording mode or the random recording mode if the data area of the write-once information storage medium is divided into a plurality of borders are provided.

According to an aspect of the present invention, there is provided a write-once information storage medium including at least one data area for recording user data; and at least one recording management data area for recording recording management data needed to use the at least one data area by dividing the at least one data area into a plurality of borders when recording the user data in a sequential recording mode and/or a random recording mode in the at least one data area.

According to another aspect of the present invention, there is provided a method of recording data on a write-once information storage medium including a data area divided into a plurality of closed borders for reproduction and a last open border in which new data can be recorded. The method includes recording user data in a sequential recording mode or a random recording mode in the last border; and creating and recording recording management data including a last border entry, which contains a starting address and a last recorded address of the last border and state information indicating whether the last border is a closed border for reproduction and whether the last border will be used in the sequential recording mode or the random recording mode.

According to another aspect of the present invention, there is provided a data recording apparatus recording data on a write-once information storage medium including a data area divided into a plurality of closed borders for reproduction and a last open border in which new data can be recorded. The apparatus includes a recording/reading unit recording data on the write-once information storage medium and reading the recorded data; and a controlling unit controlling the recording/reading unit to record user data in a sequential recording mode or a random recording mode, creating recording management data including a last border entry, which contains a starting address and a last recorded address of the last border and state information indicating whether the last border is a closed border for reproduction and whether the last border will be used in the sequential recording mode or the random recording mode, and controlling the recording/reading unit to record the recording management data on the write-once information storage medium.

According to another aspect of the present invention, there is provided a method of reproducing data recorded on a write-once information storage medium including a data area divided into a plurality of borders. The method includes reading last recorded recording management data from the write-once information storage medium; obtaining a starting address and a last recorded address of a last border from the recording management data; determining where a last updated file system was recorded based on the starting address and the last recorded address of the last border; and reading and reproducing the last updated file system.

According to another aspect of the present invention, there is provided a data reproducing apparatus reproducing data recorded on a write-once information storage medium including a data area divided into a plurality of borders. The apparatus includes a reading unit reading data recorded on the write-once information storage medium; and a controlling unit controlling the reading unit to read last recorded recording management data from the write-once information storage medium, determining where a last updated file system was recorded based on a starting address and a last recorded address of a last border included in the recording management data, and controlling the reading unit to read the last updated file system from the write-once information storage medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structure of a single-recording-layer-write-once information storage medium according to an embodiment of the present invention;

FIG. 2 illustrates the structure of a double-recording-layer-write-once information storage medium according to an embodiment of the present invention;

FIGS. 3A and 3B are views illustrating a method of updating recording management data (RMD) in an RMD area according to an embodiment of the present invention;

FIG. 4 illustrates a format of RMD according to an embodiment of the present invention;

FIG. 5 illustrates the structure of a last border entry illustrated in FIG. 4 according to an embodiment of the present invention;

FIG. 6 illustrates a “list of closed border entries” and a “recording state of last open border” when data was recorded in a last open border in a random recording mode according to an embodiment of the present invention;

FIG. 7 illustrates a “list of closed border entries” and a “recording state of last open border” when data was recorded in a last open border in a sequential recording mode according to an embodiment of the present invention;

FIGS. 8A and 8B illustrate a data area where a last border, in which data was recorded in the random recording mode, is closed and where a new last border is created according to an embodiment of the present invention;

FIGS. 9A and 9B illustrate a data area where a last border, in which data was recorded in the sequential recording mode, is closed and where a new last border is created according to an embodiment of the present invention;

FIG. 10 illustrates RMD updated after closing a last open border according to an embodiment of the present invention;

FIG. 11 is a block diagram of a data recording and/or reproducing apparatus according to an embodiment of the present invention;

FIG. 12 is a flowchart illustrating a method of recording data on a write-once information storage medium according to an embodiment of the present invention;

FIG. 13 is a flowchart illustrating S830 of FIG. 12 according to an embodiment of the present invention; and

FIG. 14 is a flowchart illustrating a method of reproducing data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

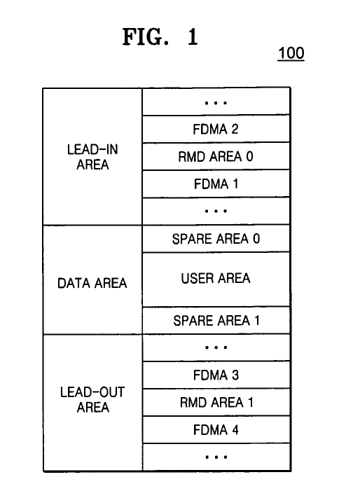

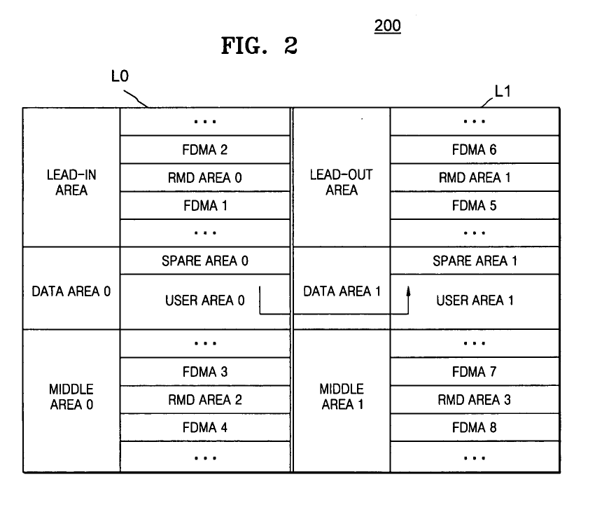

FIG. 1 illustrates the structure of a single-recording-layer-write-once information storage medium 100 according to an embodiment of the present invention. FIG. 2 illustrates the structure of a double-recording-layer-write-once information storage medium 200 according to an embodiment of the present invention.

Referring to FIG. 1, the single-recording-layer-write-once information storage medium 100 includes a lead-in area, a data area, and a lead-out area disposed sequentially from the inner circumference to the outer circumference thereof. The lead-in area includes at least one finalized disc management area (FDMA) and a recording management area. In the example of FIG. 1, the lead-in area includes FDMA 1 and FDMA 2, and RMD area 0. The data area includes spare area 0 and spare area 1, and a user area. The lead-out area includes FDMA 3 and FDMA 4, and RMD area 1.

An RMD area is an area where RMD according to aspects of the present invention is recorded. A detailed description of the RMD area will be made later.

The spare areas are areas used for replacing defective user data recorded in the user area. In the present embodiment, at least one spare area is allotted to the data area by a data recording and/or reproducing apparatus or by a user's choice when the single-recording-layer-write-once information storage medium 100 is initialized.

Also, a temporary disc defect structure (TDDS) and a temporary defect list (TDFL) other than the user data re-recorded for defect management are recorded in the spare area.

The TDDS (not separately shown) may include a TDDS identifier, an update counter, information regarding where a last TDFL, and final disc and drive information are recorded, and information regarding the size of the spare area allotted to the data area.

The TDFL (not separately shown) may include a TDFL identifier, an update counter, the number of defective factors, and defective factors. A defective factor includes state information, position information of a defective cluster, and position information of a replacement cluster. The state information may indicate the type of defects and replacement information.

Until the single-recording-layer write-once information storage medium 100 is completed, the TDFL and TDDS in the spare area (spare area 0 and/or spare area 1) are updated at predetermined intervals. When the single-recording-layer write-once information storage medium 100 is completed, last updated TDFL and TDDS are recorded in at least one of the FDMAs (FDMA 1, FDMA 2, FDMA 3 or FDMA 4) as a defect list (DFL) and a disc defect structure (DDS), respectively. In doing so, a reproducing apparatus for re-recordable information storage media can reproduce data from the single-recording-layer write-once information storage medium 100.

Referring to FIG. 2, the double-recording-layer-write-once information storage medium 200 includes a first recording layer (L0) including a lead-in area, a first data area (data area 0), and a first middle area (middle area 0) and a second recording layer (L1) including a second middle area (middle area 1), a second data area (data area 1), and a lead-out area. The structures of the L0 and L1 are almost the same as the single-recording-layer-write-once information storage medium 100 of FIG. 1. User data is recorded from the inner circumference to the outer circumference of user area 0 of the first recording layer L0. When the user data cannot be recorded in user area 0 anymore, the user data is recorded in the second recording layer L1 from the inner circumference to the outer circumference of user area 1.

Although not shown in FIGS. 1 and 2, when a data recording and/or reproducing apparatus is initialized to use the single-recording-layer-write-once information storage medium 100 or the double-recording-layer-write-once information storage medium 200, the RMD areas may be allotted to the data area by the data recording and/or reproducing apparatus or according to a user's choice in order to increase the number of times that the RMD is updated.

The RMD areas for recording only RMD are allotted to the lead-in and/or lead-out areas of the single-recording-layer-write-once information storage medium 100 of FIG. 1 and the double-recording-layer-write-once information storage medium 200 of FIG. 2. However, TDDS and RMD may be recorded together in one cluster or in separate clusters in the RMD areas.

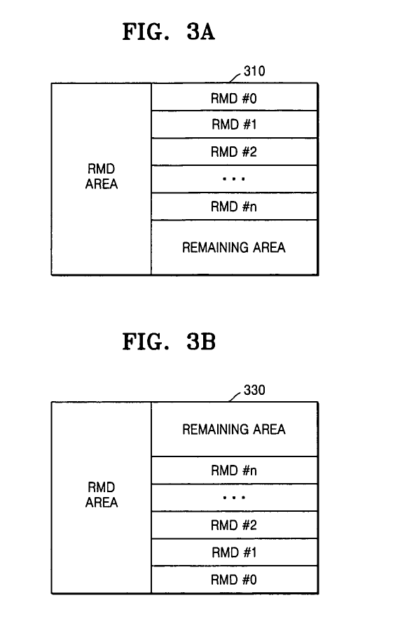

FIGS. 3A and 3B are views for illustrating a method of updating RMD in an RMD area according to an embodiment of the present invention. Referring to FIG. 3A, RMD #0 through #n is recorded from the inner circumference to the outer circumference of the RMD area 310, which is for example, one of the RMD areas in either the single-recording-layer-write-once information storage medium or the first recording layer L0 of the double-recording-layer-write-once information storage medium. Referring to FIG. 3B, RMD #0 through #n is recorded from the outer circumference to the inner circumference of the RMD area 330 which is, for example, the second recording layer L1 of the double-recording-layer-write-once information storage medium.

In the present embodiment, if the single-recording-layer-write-once information storage medium 100 or the double-recording-layer-write-once information storage medium 200 includes a plurality of RMD areas, the RMD areas are sequentially used. In other words, after an RMD area is used or filled, updated RMD is recorded in a next RMD area.

In the case of the double-recording-layer-write-once information storage medium 200 of FIG. 2, the RMD areas are sequentially used in the order of RMD area 0, RMD area 1, RMD area 2, and RMD area 3. Since the order in which the RMD areas are used and the direction in which each of the RMD areas is used are predetermined, the data recording and/or reproducing apparatus can easily and quickly access the last updated RMD recorded on the double-recording-layer-write-once information storage medium 200.

FIG. 4 illustrates a format of RMD 400 according to an embodiment of the present invention. Since the RMD 400 is recorded on the single-recording-layer-write-once information storage medium 100 or the double-recording-layer-write-once information storage medium 200, the data recording and/or reproducing apparatus can record and reproduce data in a sequential recording mode and/or a random recording mode. The single-recording-layer-write-once information storage medium 100 or the double-recording-layer-write-once information storage medium 200 can be divided into a plurality of borders before being used.

Referring to FIG. 4, the RMD 400 includes an RMD header 410, a list of closed border entries 430, and a recording state of last open border 450. The RMD header 410 includes an RMD identifier 411, a last border entry 413, and a total number of borders 415. The RMD identifier 411 is for identifying each RMD recorded in the RMD area.

The last border entry 413 is information regarding the position and state of a last border out of a plurality of borders in the data area of the single-recording-layer-write-once information storage medium 100 or the double-recording-layer-write-once information storage medium 200. The total number of borders 415 indicates a total number of borders in the single-recording-layer-write-once information storage medium 100 or the double-recording-layer-write-once information storage medium 200.

In the present embodiment, the single-recording-layer-write-once information storage medium 100 or the double-recording-layer-write-once information storage medium 200 is used in units of borders according to the direction in which the user area is used. The last border denotes a border used last among a plurality of borders. Thus, only the last border can be an open border, and the borders before the last border are closed borders.

FIG. 5 illustrates the structure of the last border entry 413 illustrated in FIG. 4 according to an embodiment of the present invention. The last border entry 413 includes state information indicating a state of a last border, a starting address of the last border, and a last recorded address (LRA). The starting address denotes an address of a physical starting sector of the last border. The LRA denotes an address of a physical sector of a position where data is last recorded in the last border.

The state information indicates whether the last border is empty, being used in the random recording mode or in the sequential recording mode, or closed. Each closed border entry in the list of closed border entries 430 includes a starting address of each closed border and an LRA of a position where data is last recorded in each closed border. The closed border entries do not include state information of the closed borders unlike the last border entry 413. The reason why only the last border entry 413 includes the state information of a last border is that data is not recorded in the closed borders and that the closed borders are used only for reproduction. Thus, it does not matter in what recording mode that the data was recorded in the closed borders. Further, if the last border is closed, it denotes that the single-recording-layer-write-once information storage medium 100 or the double-recording-layer-write-once information storage medium 200 is completed and will be used for only reproduction.

The recording state of last open border 450 indicates the recording state of a last open border. Different recording state information is recorded in the recording state of last open border 450 depending on whether data was recorded in the sequential recording mode or the random recording mode.

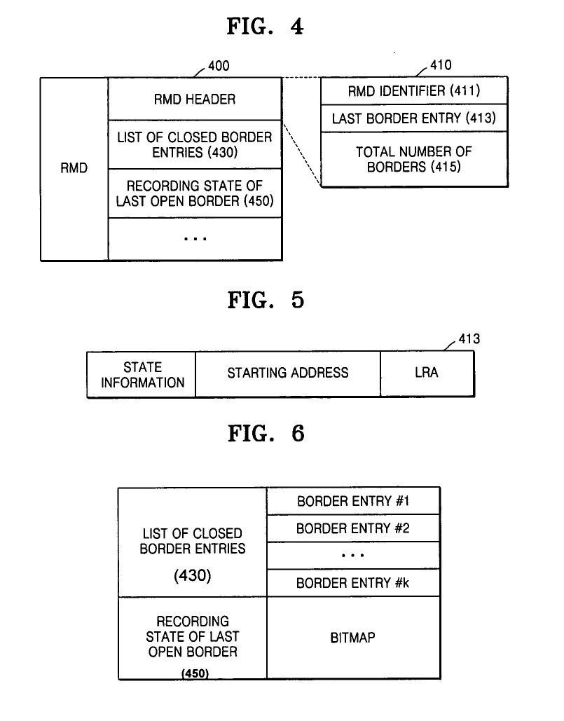

FIG. 6 illustrates a “list of closed border entries” 430 and a “recording state of last open border” 450 when data was recorded in a last open border in the random recording mode according to an embodiment of the present invention. Referring to FIG. 6, the “list of closed border entries” includes border entries #1 through #k (k is a variable equal to or greater than 1), which are entries of k closed borders used before a last border.

When data is recorded in the last open border in the random recording mode, the “recording state of last open border” 450 includes a bitmap to indicate the recording state of the last open border. A bitmap is formed by allocating different bit values to a data-recorded cluster and a data-unrecorded cluster. A cluster is a unit of recording and reproducing data on/from a write-once information storage medium.

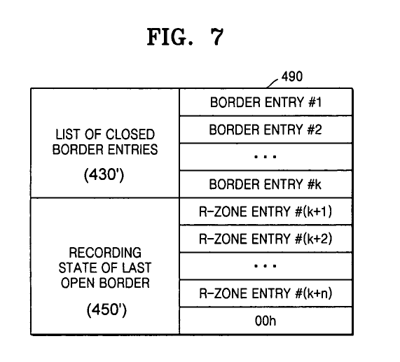

FIG. 7 illustrates a “list of closed border entries” 430′ and a “recording state of last open border” 450′ when data was recorded in a last open border in the sequential recording mode according to an embodiment of the present invention. Referring to FIG. 7, the “list of closed border entries” 430′ includes (k is a variable equal to or greater than 1) #1 through #k border entries, which are entries of k closed borders used before a last border.

When data is recorded in the last open border in the sequential recording mode, the “recording state of last open border” 450′ includes a list of recording zone (R-zone) entries, which are entries of R-zones included in the last open border, to indicate the recording state of the last open border. In the present embodiment, before recording data in the last open border in the sequential recording mode, the last open border is divided into at least one R-zone. Then, the data is recorded in the sequential recording mode in the last open border in units of R-zones.

Referring back to FIG. 7, the “recording state of last open border” 450′ includes R-zone entries #(k+1) through #(k+n) (k and n are variables equal to or greater than 1). Each of the R-zone entries #(k+1) through #(k+n) includes a starting address and an LRA of each R-zone.

If data was recorded in the last open border in the sequential recording mode, the total number of borders 415 in the RMD 400 illustrated in FIG. 4 indicates a starting R-zone entry number of the last border.

The total number of borders 415 can be used to determine a position where the bitmap, which indicates the recording state of the last open border, starts in the RMD 400 when the state information of the last border in the last border entry 413 indicates that the last border is being used in the random recording mode. In other words, a starting position of the bitmap of the last open border in the RMD 400 can be calculated using the following equation:
Starting position of bitmap of the last border=(length of RMD occupied by one border entry)*(“total number of borders”−1))+(starting position of “list of closed border entries”) Equation 1

When the state information of the last border entry 413 indicates that the last border is being used in the sequential recording mode, the total number of borders 415 can be used to calculate a position where the first R-zone entry in the “list of R-zone entries of last open border,” which indicates the recording state of a last open border, starts in the RMD 400. The position where the first R-zone entry in the “list of R-zone entries of last open border” starts in the RMD 400 can be calculated using the following equation:
Starting position of the first R-zone of the last (open) border=(length of RMD occupied by one border entry)*(“total number of borders”−1))+(starting position of “list of closed border entries”) Equation 2

As described above, each border has a border entry including a starting address of the border and an LRA of the border. Therefore, the data recording and/or reproducing apparatus can quickly obtain information regarding the latest file system from the single-recording-layer-write-once information storage medium 100 or the double-recording-layer-write-once information storage medium 200.

For example, in the case of an universal disk format (UDF) file system, an anchor point of a closed border must be at least two out of: 1) logical sector number 256, 2) last logical sector number-256, or 3) a last logical sector number. Since it is possible to know the starting address and the LRA of each border in the case of the UDF file system, the data recording and/or reproducing apparatus can quickly obtain information regarding where a file system was recorded.

In addition, when closing a last border in which data was recorded in the random recording mode, bitmaps of borders that have already been closed are not included in the RMD 400. Instead, a bitmap of a newly created open border is included in the RMD 400, thereby securing the maximum number of useable borders. If the bitmaps of the closed borders are included in the RMD 400, bitmap data to be included in the RMD 400 increases. In this case, if the size of the RMD 400 is fixed, recording space available for border entries #1 through #k will be reduced.

Hence, in the present embodiment, the bitmaps of the closed borders are not included in the RMD 400, thereby increasing the space available for border entries #1 through #k. Accordingly, more borders can be allotted to the single-recording-layer-write-once information storage medium 100 or the double-recording-layer-write-once information storage medium 200.

In addition, when closing a last border in which data was recorded in the sequential recording mode, all the R-zones in the last border are merged into one R-zone, which is represented by an R-zone entry (border entry). Thus, an open border can be divided into as many R-zones as necessary to maximize the efficiency of use of the write-once information storage medium.

For example, when the size of the RMD 400 is fixed and the number of R-zone entries that can be included in one RMD 400 is 7,000, if 5,000 R-zones are used in the first border and thus 5,000 R-zone entries are included in the RMD, the second border can use only 2,000 R-zones. However, according to aspects of the present invention, when closing a border, if all the R-zones included in the border are merged into one R-zone represented by one R-zone (=border) entry, the second border can use 6,999 R-zones, thereby enhancing efficiency of using the single-recording-layer-write-once information storage medium 100 or the double-recording-layer-write-once information storage medium 200.

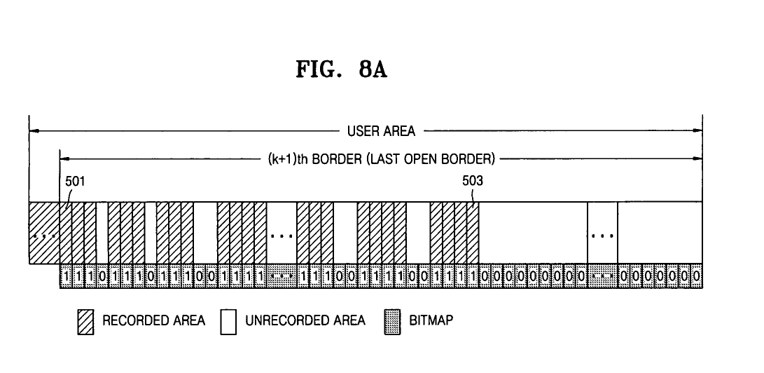

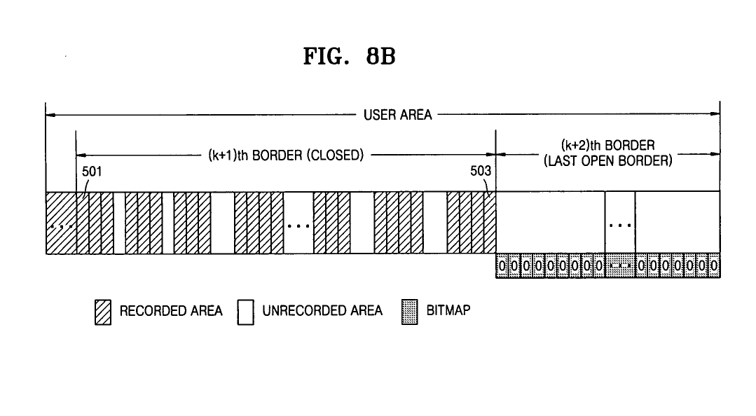

FIGS. 8A and 8B illustrate a data area where a last border, in which data was recorded in the random recording mode, is closed and where a new last border is created according to an embodiment of the present invention.

FIG. 8A illustrates k closed borders and the (k+1)^{th} border that is a last open border of the user area. Data was recorded from a first position 501 to a last position 503 in the (k+1)^{th} border in the random recording mode. The bitmap of the (k+1)^{th} border in RMD corresponding to the data area is also illustrated in FIG. 8A. The bitmap was formed by allotting “1” to clusters where data was recorded and “0” to clusters where data was not recorded.

FIG. 8B illustrates the data area where the (k+1)^{th} border of FIG. 8A is closed and the (k+2)^{th} border, which is a new last border, is open within the user area. The scope of the (k+1)^{th} border extends from the first position 501 to the last position 503. The bitmap of the (k+2)^{th} border in the RMD corresponding to the data area is also illustrated in FIG. 8B. Since no data has been recorded in the (k+2)^{th} border, bit values in the bitmap are “0.”

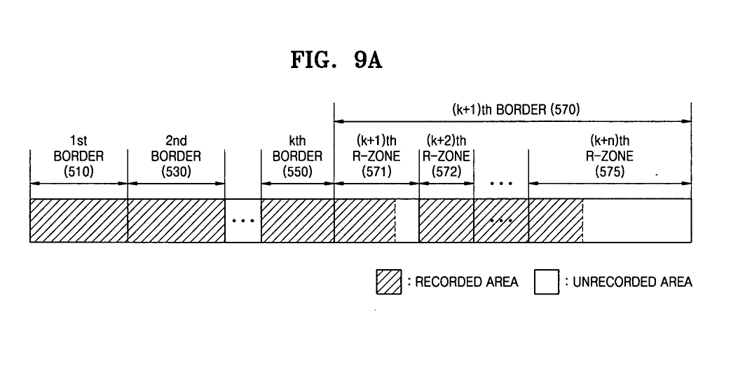

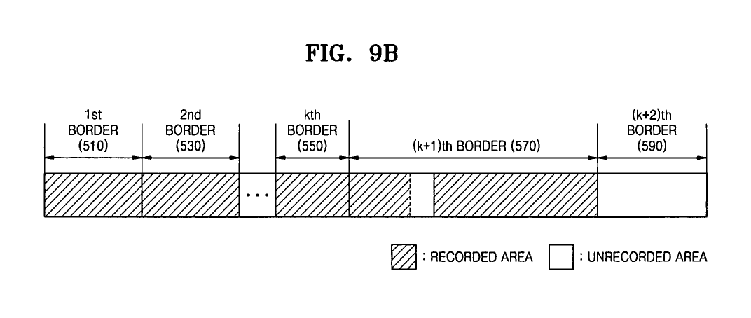

FIGS. 9A and 9B illustrate a data area where a last border, in which data was recorded in the sequential recording mode, is closed and where a new last border is created according to an embodiment of the present invention. FIG. 9A illustrates k closed borders 510 through 550 and the (k+1)^{th} border 570, which is a last open border. The (k+1)^{th} border 570 includes (k+1)^{th} through (k+n)^{th} R-zones 571 through 575. Data was recorded from a first position to a second position in the (k+n)^{th} R-zone in the sequential recording mode. Thus, the second position would correspond with the LRA of the last border entry.

FIG. 9B illustrates the data area where the (k+1)^{th} border 570 of FIG. 9A is closed and the (k+2)^{th} border 590, which is a new last border, is open. The (k+1)^{th} R-zone 571 through a last position of the (k+n)^{th} R-zone 575, where data was recorded, are merged into one R-zone to become the (k+1)^{th} border. In other words, the starting position of the (k+1)^{th} R-zone 571 through the last position of the (k+n)^{th} R-zone 575 where data was recorded becomes the (k+1)^{th} border that is closed.

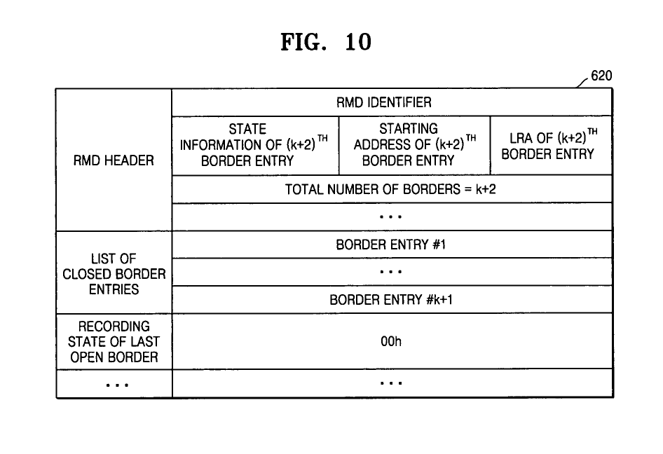

FIG. 10 illustrates RMD 620 reflecting the recording management state of a write-once information storage medium after, as illustrated in FIGS. 8B and 9B, closing the (k+1)^{th} border, which is a previous last open border according to an embodiment of the present invention. Referring to the RMD 620 of FIG. 10, the write-once information storage medium includes (k+2) borders, and a last border entry includes the state information, the starting address, and the LRA of the (k+2)^{th} border, which is a new last open border.

As illustrated in FIGS. 8B and 9B, if the (k+1)^{th} border, which is the previous last open border, is closed and the (k+2)^{th} border, which is the new last open border, is created, the data recording and/or reproducing apparatus updates previous RMD, creates the RMD 620 illustrated in FIG. 10, and records the RMD 620 in the appropriate RMD area. Since the last open border has become the (k+2)^{th} border, the RMD 620 will be different from the previous RMD. As such, the last border entry will be changed, the “total number of borders” will be increased by one, and the (k+1)^{th} border entry will be added to the “list of closed border entries.”

The “recording state of last open border” in the RMD 620 of FIG. 10 indicates the state of being empty. In other words, no data has been recorded in the (k+2)^{th} border, which is a new last open border. If the write-once information storage medium in this state is loaded into the data recording and/or reproducing apparatus, the data recording and/or reproducing apparatus informs a host of the state of a last open border read from the “recording state of last open border” of last recorded RMD on the write-once information storage medium. Then, the host determines in which recording mode data will be recorded in the last open border (k+2)^{th} and issues a recording command.

If the last border is closed to complete the write-once information storage medium, there is no need to create a new last border in the data area. As described above, if the write-once information storage medium is complete, final management information of the write-once information storage medium, such as the TDFL and the TDDS, is recorded in the FDMA. Then, the data recording and/or reproducing apparatus can access the FDMA and determine whether the write-once information storage medium is complete. Alternatively, last recorded RMD may be obtained, and, based on the state information of a last border entry read from the last recorded RMD, it may be determined whether the write-once information storage medium is complete.

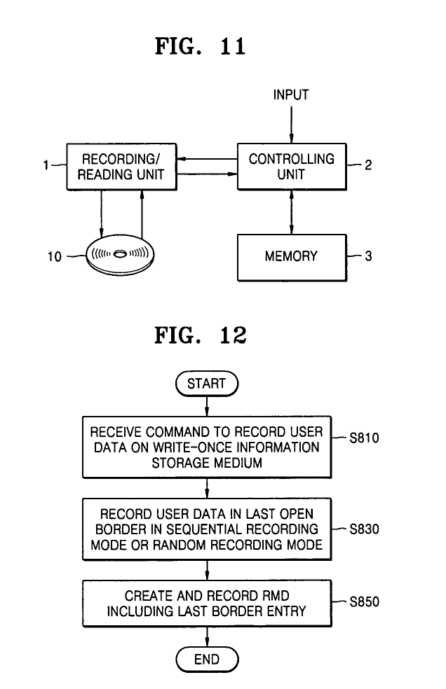

FIG. 11 is a block diagram of a data recording and/or reproducing apparatus according to an embodiment of the present invention. Referring to FIG. 11, the data recording and/or reproducing apparatus includes a recording/reading unit 1, a controlling unit 2, and a memory 3. A write-once information storage medium 10 is either the single-recording-layer-write-once information storage medium 100 or the double-recording-layer-write-once information storage medium 200 of FIG. 1 or 2, respectively, according to an embodiment of the present invention.

The controlling unit 2 controls the recording/reading unit 1 to record and/or reproduce data on/from the write-once information storage medium 10. After recording the data, the recording/reading unit 1 reads the recorded data to confirm the existence of the recorded data. The controlling unit 2 controls the entire operation of the data recording and/or reproducing apparatus.

After the write-once information storage medium 10 is loaded into the data recording and/or reproducing apparatus, the data recording and/or reproducing apparatus reads information, such as a last updated RMD, a TDDS, and a TDFL, from the write-once information storage medium 10 and stores the information in the memory 3. Thereafter, if user data is recorded in a last open border of the write-once information storage medium 10 in the sequential recording mode or the random recording mode and RMD needs to be updated, the controlling unit 2 creates updated RMD with reference to the RMD, which is stored in the memory 3 and read from the write-once information storage medium 10.

A method of recording data on the write-once information storage medium 10 by the data recording and/or reproducing apparatus of FIG. 10 according to an embodiment of the present invention will now be described. FIG. 12 is a flowchart illustrating a method of recording data on the write-once information storage medium 10 according to an embodiment of the present invention.

Although not shown in the drawings, when the write-once information storage medium 10 is loaded into the data recording and/or reproducing apparatus, the data recording and/or reproducing apparatus is initialized to use the write-once information storage medium 10. In other words, the controlling unit 2 reads basic control information needed to use the write-once information storage medium 10 and the last updated TDFL, TDDS, and RMD from the lead-in and/or lead-out area and stores the basic control information and the last updated TDFL, TDDS, and RMD in the memory 3.

The controlling unit 2 obtains the state information, the starting address and the LRA of the last border from the last updated RMD. The controlling unit 2 determines where a last updated file system was recorded based on the starting address and the LRA of the last border, reads the last updated file system, and stores the last updated file system in the memory 3. In addition, the controlling unit 2 obtains the “recording state of last open border” of the RMD and informs the host (not shown) of the state of a last open border.

After the data recording and/or reproducing apparatus is initialized to use the write-once information storage medium 10, if the data recording and/or reproducing apparatus receives a command to record user data on the write-once information storage medium 10 and the user data from the host (S810), the controlling unit 2 records the user data in the last open border of the write-once information storage medium 10 in the sequential recording mode or the random recording mode (S830).

The host determines a data recording mode based on information regarding the recording state of the last open border received from the controlling unit 2. In other words, if the “recording state of last open border” indicates that no data has been recorded in the last open border, the host determines in which recording mode data will be recorded in the last open border and transmits a recording command to the controlling unit 2. However, if the “recording state of last open border” indicates that data has already been recorded in the last open border in the random recording mode or the sequential recording mode, the host commands the controlling unit 2 to record new data in a matching recording mode.

The data recording and/or reproducing apparatus creates updated RMD with reference to the RMD, which is stored in the memory 3 at predetermined timing and read from the write-once information storage medium 10, and records the updated RMD in the RMD area (S850). The structure of the updated RMD is identical to the RMD 400 of FIG. 4. As described above, the contents of the “recording state of last open border” included in the updated RMD differ according to whether data was recorded in the random recording mode or the sequential recording mode in the last open border.

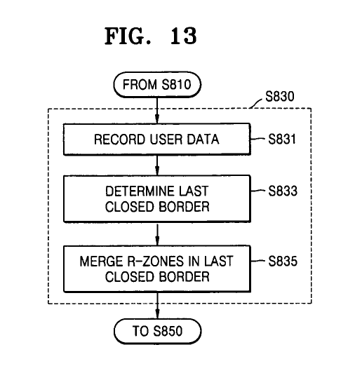

FIG. 13 is a flowchart illustrating S830 of FIG. 12 according to an embodiment of the present invention. Specifically, FIG. 13 illustrates a method of closing a last open border after recording data in the last open border in the sequential recording mode.

First, user data is recorded in the last open border in units of R-zones (S831). When the last open border is closed at the command of a user or the host, the controlling unit 2 determines the extent from a starting position to a last position of the last open border where the user data was recorded as a last closed border (S833).

The controlling unit 2 merges at least one R-zone included in the last closed border into one R-zone (S835). S833 and S835 may be better understood with reference to FIGS. 9A and 9B.

As described above, when closing the last open border, the controlling unit 2 creates updated RMD and records the updated RMD in the RMD area of the write-once information storage medium 10. The time when the RMD will be updated can be determined in diverse ways. For example, the RMD may be updated at predetermined intervals or after the completion of a round of recording operation. Alternatively, the RMD may be updated if a predetermined amount of user data is recorded on the write-once information storage medium 10.

A method of reproducing RMD recorded on the write-once information storage medium 10 according to an embodiment of the present invention will now be described. A data reproducing apparatus according to the present embodiment uses the data recording and/or reproducing apparatus of FIG. 10. However, since the data reproducing apparatus is for reproduction only, the recording/reading unit 1 functions as a reading unit only, and the controlling unit 2 performs only reading-related functions.

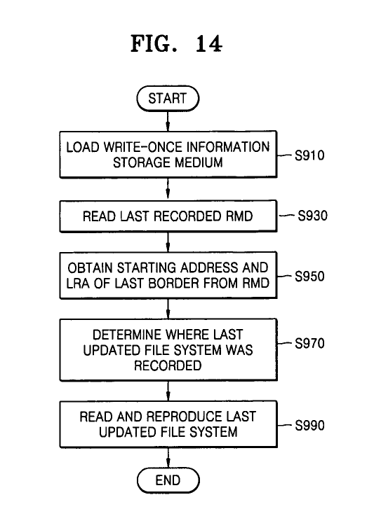

FIG. 14 is a flowchart illustrating a method of reproducing data according to an embodiment of the present invention. When the write-once information storage medium 10 is loaded into the data reproducing apparatus (S910), the data reproducing apparatus reads a last updated RMD from the write-once information storage medium 10 and stores the last updated RMD in the memory 3 (S930).

The last updated RMD from the write-once information storage medium 10 is read when the data reproducing apparatus is initialized to use the write-once information storage medium 10. In other words, the controlling unit 2 reads basic control information needed to use the write-once information storage medium 10 and the last updated TDFL, TDDS stored in an FDMA, and RMD from the lead-in and/or lead-out area and stores the basic control information and the last updated TDFL, TDDS, and RMD in the memory 3.

The controlling unit 2 obtains the state information, starting address, and the LRA of the last border from the last updated RMD structured like the RMD 400 of FIG. 4 (S950). The controlling unit 2 determines where a last updated file system was recorded based on the starting address and the LRA of the last border (S970). For example, in the case of an UDF file system, an anchor point must be at least two out of: 1) a logical sector number 256, 2) a last logical sector number-256, or 3) a last logical sector number in the last border. Therefore, the data reproducing apparatus can determine where the last updated file system was recorded based on the starting address and the LRA of the last border.

If the last border is open and no data has been recorded in the last border, the last updated file system may not be recorded in the last border. In this case, the controlling unit 2 obtains the starting address and the LRA of a last closed border from the list of closed border entries 430 in the RMD 400. Then, the controlling unit 2 can determine where the last updated file system was recorded based on the starting address and the LRA of the last closed border.

The controlling unit 2 reads and reproduces the last updated file system from the write-once information storage medium 10 (S990). By reproducing the last updated file system, the controlling unit 2 interprets the read file system and recognizes the type of user data recorded on the write-once information storage medium 10, the location where the user data was recorded, and a directory structure.

Although not shown in the drawings, the host determines a data reproducing mode based on information regarding the recording state of the last open border received from the controlling unit 2. In other words, the host determines in which recording mode data was recorded in the last open border based on the “recording state of last open border” and commands the controlling unit 2 to reproduce the data according to the determined recording mode.

As described above, if RMD according to aspects of the present invention is recorded on a write-once information storage medium and a data area is divided into a plurality of borders and/or recording zones, data can be recorded on the write-once information storage medium in a sequential recording mode or a random recording mode. Therefore, the write-once information storage medium can be used with enhanced ease and efficiency.

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

1. A write-once information storage medium, comprising:
at least one data area used to record user data; and
at least one recording management data area used to record recording management data needed to use the at least one data area by dividing the at least one data area into a plurality of borders when recording the user data in a sequential recording mode and/or a random recording mode in the at least one data area.

2. The medium of claim 1, wherein the recording management data comprises a last border entry including a starting address and a last recorded address of a last border, wherein the last border entry includes state information indicating whether the last border is a closed border for reproduction and whether the last border will be used in the sequential recording mode and/or the random recording mode.

3. The medium of claim 2, wherein the recording management data comprises a list of closed border entries including a starting address and a last recorded address of each closed border for reproduction.

4. The medium of claim 2, wherein the last border entry comprises a list of at least one recording zone entry of the last border, each recording zone entry including a starting address and a last recorded address of at least one recording zone included in the last border when the user data was recorded in the last border in units of recording zones in the sequential recording mode.

5. The medium of claim 2, wherein the last border entry comprises a bitmap indicating a recording state of the last border when the user data was recorded in the last border in the random recording mode.

6. The medium of claim 2, wherein the state information indicates that the last border is closed when the write-once information storage medium is complete.

7. A method of recording data on a write-once information storage medium comprising a data area divided into a plurality of closed borders for reproduction and a last open border in which new data is recordable, the method comprising:
recording user data in a sequential recording mode or a random recording mode in the last open border; and
creating and recording recording management data including a last border entry, which contains a starting address and a last recorded address of the last open border and state information indicating whether the last border is a closed border for reproduction and whether the last open border will be used in the sequential recording mode or the random recording mode.

8. The method of claim 7, wherein the last border entry comprises a list of at least one recording zone entry of the last border, each recording zone entry including a starting address and a last recorded address of at least one recording zone included in the last border, when the user data was recorded in the last border in units of recording zones and in the sequential recording mode.

9. The method of claim 7, wherein the last border entry comprises a bitmap indicating a recording state of the last border when the user data is recorded in the last border in the random recording mode.

10. The method of claim 7, wherein the last border entry comprises the state information indicating whether the last border is closed or open.

11. The method of claim 7, wherein the recording management data comprises a list of closed border entries including a starting address and a last recorded address of each of the plurality of closed borders.

12. The method of claim 7, wherein the state information indicates that the last border is closed when the write-once information storage medium is complete.

13. The method of claim 7, wherein the recording of the user data comprises determining an extent from a starting position to a last position of the last border where the user data is recorded as a last closed border and merging at least one recording zone included in the last closed border into one recording zone, and the creating and recording of the recording management data comprises creating and recording the recording management data including a list of closed border entries, which contain the starting address and the last recorded address of the last closed border, when recording the user data in the last border in the sequential recording mode and in units of recording zones.

14. A data recording apparatus recording data on a write-once information storage medium comprising a data area divided into a plurality of closed borders for reproduction and a last open border in which new data is recordable, the apparatus comprising:
a recording/reading unit recording data on the write-once information storage medium and reading the recorded data; and
a controlling unit controlling the recording/reading unit to record user data in a sequential recording mode or a random recording mode, creating recording management data including a last border entry, which contains a starting address and a last recorded address of the last border and state information indicating whether the last border is a closed border for reproduction and whether the last border will be used in the sequential recording mode or the random recording mode, and controlling the recording/reading unit to record the recording management data on the write-once information storage medium.

15. The apparatus of claim 14, wherein the last border entry comprises a list of at least one recording zone entry of the last border, each recording zone entry including a starting address and a last recorded address of at least one recording zone included in the last border, when the user data was recorded in the last border in units of recording zones and in the sequential recording mode.

16. The apparatus of claim 14, wherein the last border entry comprises a bitmap indicating a recording state of the last border when the user data is recorded in the last border in the random recording mode.

17. The apparatus of claim 14, wherein the last border entry comprises the state information indicating whether the last border is closed or open.

18. The apparatus of claim 14, wherein the recording management data comprises a list of closed border entries including a starting address and a last recorded address of each of the plurality of closed borders.

19. The apparatus of claim 14, wherein the state information indicates that the last border is closed when the write-once information storage medium is complete.

20. The apparatus of claim 14, wherein when recording the user data in the last border in the sequential recording mode and in units of recording zones, the controlling unit determines an extent from a starting position to a last position of the last border where the user data is recorded as a last closed border, merges at least one recording zone included in the last closed border into one recording zone, and creates recording management data including a list of closed border entries, which contain a starting address and a last recorded address of the last closed border.

21. The apparatus of claim 20, wherein the controlling unit creates the recording management data including the last closed border at predetermined intervals.

22. The apparatus of claim 20, wherein the controlling unit creates the recording management data including the last closed border after a threshold amount of the user data is recorded on the information storage medium.

23. A method of reproducing data recorded on a write-once information storage medium comprising a data area divided into a plurality of borders, the method comprising:
reading last recorded recording management data from the write-once information storage medium;
obtaining a starting address and a last recorded address of a last border from the recording management data;
determining where a last updated file system was recorded based on the starting address and the last recorded address of the last border; and
reading and reproducing the last updated file system.

24. The method of claim 23, wherein the recording management data includes a last border entry comprising state information indicating whether the last border is a closed border for reproduction or an open border in which new data is recordable.

25. The method of claim 23, wherein the recording management data comprises a list of closed border entries including a starting address and a last recorded addresss of each closed border for reproduction.

26. The method of claim 23, wherein the recording management data comprises a list of at least one recording zone entry of the last border, each recording zone entry including a starting address and a last recorded address of at least one recording zone included in the last border.

27. The method of claim 25, wherein the determining where the last updated file system was recorded comprises:
obtaining from the list of closed border entries the starting address and the last recorded address of a last closed border if no data has been recorded in the last border; and
determining where the last update file system was recorded based on the starting address and the last recorded address of the last closed border.

28. The method of claim 24, further comprising reproducing the data recorded in the last border in a sequential recording mode or a random recording mode based on the state information indicating whether the data was recorded in the sequential recording mode or the random recoding mode.

29. A data reproducing apparatus reproducing data recorded on a write-once information storage medium comprising a data area divided into a plurality of borders, the apparatus comprising:
a reading unit reading data recorded on the write-once information storage medium; and
a controlling unit controlling the reading unit to read last recorded recording management data from the write-once information storage medium, determining where a last updated file system was recorded based on a starting address and a last recorded address of a last border included in the recording management data, and controlling the reading unit to read the last updated file system from the write-once information storage medium.

30. The apparatus of claim 29, wherein the recording management data comprises a last border entry comprising state information indicating whether the last border is a closed border for reproduction or an open border in which new data is recordable.

31. The apparatus of claim 29, wherein the recording management data comprises a list of closed border entries including a starting address and a last recorded address of each closed border for reproduction.

32. The apparatus of claim 29, wherein the recording management data comprises a list of at least one recording zone entry of the last border, each recording zone entry including a starting address and a last recorded address of at least one recording zone included in the last border.

33. The apparatus of claim 31, wherein if no data has been recorded in the last border, the controlling unit obtains the starting address and the last recorded address of a last closed border, in which the data was last recorded, from the list of closed border entries and, based on the starting address and the last recorded address of the last closed border, determines where a last update file system was recorded.

34. The apparatus of claim 29, wherein the recording management data comprises state information indicating whether the data was recorded in a sequential recording mode or a random recoding mode, and the controlling unit determines whether the data was in the sequential recording mode or the random recording mode based on the state information.

35. A computer-readable recording medium having stored thereon a program for executing a method of recording data on a write-once information storage medium comprising a data area divided into a plurality of closed borders for reproduction and a last open border in which new data is recordable, the method comprising:
recording user data in a sequential recording mode or a random recording mode in the last border; and
creating and recording recording management data including a last border entry, which contains a starting address and a last recorded address of the last border and state information indicating whether the last border is a closed border for reproduction and whether the last border will be used in the sequential recording mode or the random recording mode.

36. A computer-readable recording medium having stored thereon a program for executing a method of reproducing data recorded on a write-once information storage medium comprising a data area divided into a plurality of borders, the method comprising:
reading last recorded recording management data from the write-once information storage medium;
obtaining a starting address and a last recorded address of a last border from the recording management data;
determining where a last updated file system was recorded based on the starting address and the last recorded address of the last border; and
reading and reproducing the last updated file system.

37. A write once information storage medium for use with a recording and/or reproducing apparatus, comprising:
a plurality of borders each having an open state in which new data is recordable or a closed state in which new data is not recordable;
recording management data which comprises information used by the reproducing apparatus to control the recording of the data in the plurality of borders, such that only a last one of the plurality of borders is open or closed and the remaining plurality of borders are closed and a format of the last one of the plurality of borders depends on a type of recording mode used to record the new data.

38. The information storage medium of claim 37, wherein the type of recording mode is a sequential recording mode.

39. The information storage medium of claim 38, wherein the format of the last one of the plurality of borders comprises a plurality of recording zones used to record the new data and the recording management data comprises a starting address and last recorded address of each of the plurality of recording zones, and a border starting address and a border last recorded address for each of the plurality of borders except the last one.

40. The information storage medium of claim 37, wherein the type of recording mode is a random recording mode.

41. The information storage medium of claim 40, wherein the format of the last one of the plurality of borders comprises a bitmap indicating a recording state of clusters of the last one of the plurality of borders when in the open state.

42. The information storage medium of claim 41, wherein the recording management data of the remaining plurality of borders includes only a starting address and a last recorded address of each of the remaining plurality of borders.

43. The information storage medium of claim 41, wherein the recording management data of the remaining plurality of borders which are closed does not include bitmaps of each of the remaining plurality of borders thus increasing a storage amount available for the bitmap of the last one of the plurality of borders.

44. The information storage medium of claim 37, wherein the recording management data of the last one of the plurality of borders includes state information indicating whether the last one of the plurality of borders is closed or open, a starting address of the last one of the plurality of borders, a last recorded address of the last one of the plurality of borders, and the recording management data of the remaining plurality of borders includes a starting address and a last recorded address of each of the remaining plurality of borders.

45. The information storage medium of claim 44, wherein the state information further indicates whether the last one of the plurality of borders is open and empty and the type of the recording mode.
